(19) United States
(12) Patent Application Publication
(10) Pub. No.: US 2007/0091937 A1
(43) Pub. Date: Apr. 26, 2007

(54) System and method for estimating network tomography

(76) Inventors: Tian Bu, Edison, NJ (US); Jin Cao, Edison, NJ (US); Aiyou Chen, New Providence, NJ (US)

Correspondence Address: Michael G. Fletcher;FLETCHER YODER, P.O. Box 692289, Houston, TX, 77269-2289, US

(21) Appl. No.: 11/256,122

(22) Filed: Oct. 21, 2005

(51) Int. Cl. H04J 3/06

(52) U.S. Cl. 370/519

(57) ABSTRACT

There is provided a system and method for estimating network tomography. More specifically, there is provided a computer system configured to measure the transmission delay along a path from a source endpoint of a computer network to a plurality of destination endpoints of the computer network, wherein the path includes at least two data links and wherein at least one of the data links is shared by the plurality of destination endpoints for transmissions from the source endpoint, to calculate a characteristic function of the measured transmission delay, and to calculate a performance parameter of one of the data links based on the characteristic function.

### BACKGROUND

1. Field of the Invention

This invention relates to a system and method for calculating one or more performance parameters for a computer network

2. Discussion of The Related Art

This section is intended to introduce the reader to various aspects of art that may be related to various aspects of the present invention, which are described and claimed below. This discussion is believed to be helpful in providing the reader with background information to facilitate a better understanding of the various aspects of the present invention. Accordingly, it should be understood that these statements are to be read in this light, and not as admissions of prior art

As most people are aware, computer networks are becoming an increasingly important part of daily life. Typical computer networks include a plurality of computers interconnected to each other with routers or switches that are capable of routing transmissions between computers and/or other routers. These computers and routers may be referred to as nodes of the computer network. A smaller-scale computer network may include a relatively low number of nodes whereas a larger-scale network, such as the Internet or a corporate intranet, may include several thousand nodes (if not more). Moreover, the nodes within these computer networks, especially the larger-scale networks, may be nested and interconnected such that transmissions across the computer network may “hop” through a plurality data links and/or other nodes while in route between two nodes of the network.

For a variety of reasons, the providers and designers of computer networks have focused their attention on improving the performance (e.g., the speed and/or the efficiency) of computer networks. Often, one of the first steps in improving the performance of a computer network is determining performance parameters, such as inter-node transmission delay, within the network. For smaller-scale networks where each node communicates directly with each other node, determining performance parameters is relatively straightforward. However, for larger-scale networks where a transmission from one node may hop through a plurality of other nodes and data links in route to a destination node, the cumulative transmission time between two nodes may only provide limited direct information regarding the performance of individual nodes and/or data links along the path between the two nodes.

Further, in many computer networks, directly measuring the performance of individual data links is simply not possible and/or practical. To address this issue, network tomography techniques have been developed to facilitate the estimation of individual data link performance based on the end-to-end performance of a computer network. In other words, like medical tomography that enables doctors to “see” inside a person's body, network tomography enables computer network designers to “see” inside the computer network to the individual data links. In addition, these network tomography techniques may also be employed to estimate end-to-end performance in those cases where individual data link performance across the network is known.

As those of ordinary skill in the art will appreciate, there are numerous conventional techniques for network tomography. For example, in one conventional technique, “probe” packets are transmitted through the computer network from a source node to a plurality of destination nodes within the computer network. The performance parameters of individual data links are then inferred by correlating the performance statistics (e.g., the packet transmission time) of each of the probe packets. Conventionally, this correlation involves performing a mathematical convolution operation on one or more modeling equations that can be used to estimate the performance parameters of the data links. As will be appreciated, however, the convolution operation is computationally complex, and, as such, there are a number of modeling equations that cannot be employed in conventional network tomography systems due to this complexity. In other words, the computation complexity of the convolution operation limits conventional systems to employing relatively simple modeling equations that sacrifice accuracy for the computational simplicity required by the convolution operation.

An improved system or method for estimating network tomography would be desirable.

### SUMMARY

Certain aspects commensurate in scope with the disclosed embodiments are set forth below. It should be understood that these aspects are presented merely to provide the reader with a brief summary of certain aspects the invention might take and that these aspects are not intended to limit the scope of the invention. Indeed, the invention may encompass a variety of aspects that may not be set forth below.

There is provided a system and method for estimating network tomography. More specifically, there is provided a computer system configured to measure the transmission delay along a path from a source endpoint of a computer network to a plurality of destination endpoints of the computer network, wherein the path includes at least two data links and wherein at least one of the data links is shared by the plurality of destination endpoints for transmissions from the source endpoint, to calculate a characteristic function of the measured transmission delay, and to calculate a performance parameter of one of the data links based on the characteristic function.

### BRIEF DESCRIPTION OF THE DRAWINGS

Advantages of the invention may become apparent upon reading the following detailed description and upon reference to the drawings in which:

FIG. 1 is a block diagram of an exemplary computer network configured to estimate a network tomography in accordance with one embodiment;

FIG. 2 is a flow chart illustrating an exemplary technique for calculating link delays in a computer network in accordance with one embodiment;

FIG. 3 is a flow chart illustrating an exemplary partial technique for calculating link delays based on mixture model equations in accordance with one embodiment; and

FIG. 4 is a flow chart illustrating an exemplary technique for calculating network traffic in a computer network based on data link traffic within the computer network in accordance with one embodiment.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions should be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The embodiments described below may be directed towards a system and method for estimating a network tomography for a computer network. More specifically, one or more of the embodiments described herein are directed towards a computer system configured to calculate performance parameters for one or more of a plurality of data links along an end-to-end path within a computer network by solving a data link delay modeling equation such that the deviation is minimized between a characteristic function of an observed end-to-end delay and a characteristic function of the modeling equation.

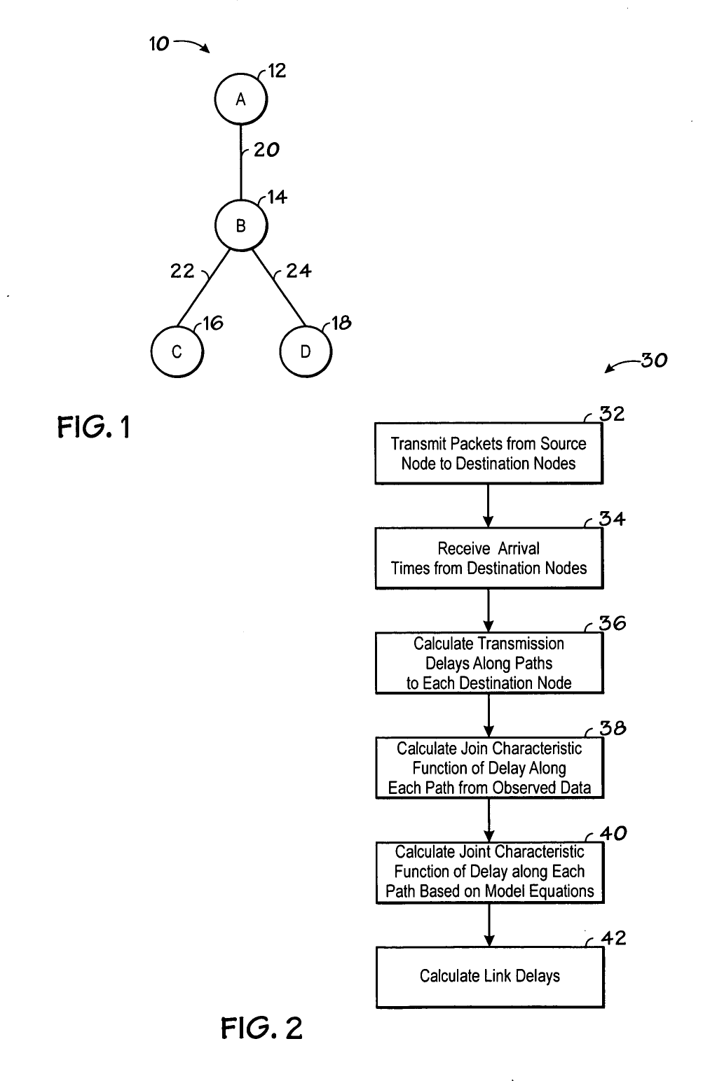

Turning now to FIG. 1, an exemplary computer network configured to estimate a network tomography in accordance with one embodiment is illustrated and generally designated by a reference numeral 10. The computer network 10 may include one or more nodes 12, 14, 16, and 18. In various embodiments, the nodes may include personal computers, servers, laptop or palmtop computers, personal digital assistants (“PDAs”), wireless devices or wireless telephones, or any other suitable processor-based device capable of communicating over the computer network 10. In addition, the nodes 12, 14, 16, and 18 may also include routers or other signal or packet switching devices. For example, in one embodiment, the node 14 may be a router configured to route packets between the node 12 and the nodes 16 and 18.

For ease of description, the nodes 12, 14, 16, and 18 are also associated (and thus labeled in FIG. 1) with a respective alphabetic identifier. More specifically, the node 12 may also be referred as the node A, the node 14 may also be referred to as the node B, the node 16 may also be referred to as the node C, and the node 18 may also be referred to as the node D. This alternate identifier scheme is provided to aid in describing signal transmission between the nodes 12, 14, 16, and 18. For example, a signal path from the node 12 through the node 14 and to the node 18 may be described as the “ABD path” as it goes from the node A through the node B to the node D. Similarly, the computer network 10 also includes the AB path, the BC path, and the BD path.

As illustrated in FIG. 1, the nodes A, B, C, and D (hereafter “A-D”) may be interconnected by one or more data links 20, 22, and 24. For example, the node A is connected to the node B by the data link 20 and the node B is connected to the node D by the data link 24. In various embodiments, the data links 20, 22, and 24 may be any type of connection or link suitable for communicatively coupling or interconnecting the nodes A-D together. For example, each of the data links 20, 22, and 24 may be a physical connection, such as a wire, an Ethernet or gigabit Ethernet cable, a category 5 cable (“cat5”), a fiber-optic cable, or the like. The data links 20, 22, and 24 may also be wireless connections that employ one or more of a variety of suitable wireless data transmission protocols, such as I.E.E.E. 802.11, WiMax™, and the like.

Those of ordinary skill in the art will appreciate that the nodes A-D within the computer network 10 are arrayed in a tree structure, known as a “two leaf” tree because of its shape. The tree structure of the computer network 10 facilitates estimation of the tomography of the computer network. As such, the remainder of the discussion below will focus on the computer networks, such as the computer network 10, which are arrayed in a tree structure. Those of ordinary skill in the art, however, will appreciate that in alternate embodiments, the techniques described herein may be applied to other network structures. In addition, it will also be appreciated that the relatively simple two leaf tree network depicted in FIG. 1 is presented primarily for illustrative purposes. As such, in alternate embodiments, the techniques presented herein may be employed with larger computer networks and/or computer networks with more complex tree structures.

As described above, the computer network 10 is arrayed in a tree structure with the node A at the “base” of the tree and the nodes C and D at the “leaves” of the tree. For ease of description, the techniques described below will be described in terms of transmissions from the base (node A) to the leaves (nodes C and D). It will be appreciated, however, that in alternate embodiments, the techniques described herein may be employed for other transmissions within the computer network 10.

The computer network 10 has three nodes that have a single data link: the base node A and the leaf nodes C and D. These nodes are referred to as endpoints, and the transmission path from one endpoint to another endpoint is referred to as an “end-to-end” transmission path. The node B, on the other hand, is an intermediate node. It will be appreciated that the computer network 10 is illustrated with a single intermediate node (the node B) for illustrative purposes only. As such, in alternate embodiments, any one of a suitable number of intermediate nodes may be arrayed between the endpoints of the computer network 10.

For the purposes of estimating the network tomography of the computer network 10, two different “end-to-end” transmission paths within the computer network 10 will be examined: the ABC path and the ABD path. Each of these paths includes one shared data link in the AB section of the path (the data link 20) and each of these paths includes one additional non-shared data link (the data link 22 for the ABC path and the data link 24 for the ABD path). Further, the node A is referred to as the “source” node, because it is the source of the two transmissions that are examined. For similar reasons, the nodes C and D are referred to as “destination” nodes. As such, it is apparent from FIG. 1 that all of the transmissions from the source node A will travel over the data link 20 until they branch out at the node B and proceed to one of the two destination nodes C or D via either the data link 22 or the data link 24.

As outlined above, among other things, the techniques provided herein facilitate the calculation of individual data link delay times (hereafter referred to as “link delays”) based on observed end-to-end path delay times. The link delays include at least two component parts: a transmission delay component and a queuing delay component. Moreover, the link delays for each of the data links are assumed to be independent (i.e., not dependent on one another).

The transmission delay component of the link delay includes the time that it takes for the signal to be transmitted across a particular one of the data links 20-24. Those of ordinary skill in the art will appreciate that the transmission delay component of the link delay is a stable, near-constant value that can be calculated based on the type of data link and the packet size to be transmitted. For example, category 5 cable introduces 1.112 bit times of delay per meter.

The second component of the link delay is the queuing delay. The queuing delay is the amount of time that a transmission from one of the nodes is backed-up or queued awaiting transmission over a particular one of the data links 20, 22, and 24. Although the queuing delay is not technically a delay of the data links 20, 22, and 24, for the purposes of the techniques described herein, it is useful to include the queuing delay with the transmission delay in calculating the link delay as both delays affect how long it takes for a transmission to be transmitted from one node to another across the data links 20, 22, and 24 once the transmission request is initiated. Further, the time that the transmission spends being routed through an intermediate node is also part of the total queuing time. Unlike the transmission delay, however, the queuing delay is a dynamic value that varies based on the number of transmissions in the computer network 10 (i.e., the network traffic). If the network traffic is low, the queue delay may be relatively low, but if the network traffic is high, the queuing delay may be relatively high (depending on the network capacity).

FIG. 2 is a flow chart illustrating an exemplary technique 30 for calculating link delays in the computer network 10 in accordance with one embodiment. The technique described with reference to FIG. 2 should be considered in conjunction with the exemplary computer network 10 previously described with reference to FIG. 1. In one embodiment, the node A may be configured to perform the technique 30. For example, the node A may have a network tomography module configured to perform the technique 30. This network tomography module may be hardware, software, firmware, or a combination of hardware, software, and/or firmware In another embodiment, another computer system or device may be configured to monitor the computer network and perform the technique 30.

As indicated by block 32 the technique 30 may begin with the source node A transmitting “probe” packets from the node A to the destination nodes C and D via the paths ABC and ABD. When these probe packets arrive at the destination nodes C and D, respectively, the nodes C and D may be configured to recognize the receipt of the probe packets and record an arrival time for the probe packets. The nodes C and D may then be configured to transmit the arrival time back to the source node A. Accordingly, the node A may also be configured to receive the arrival times from the destination nodes (block 34) and to use these arrival times along with the times that the transmission of the packets were initiated to calculate a transmission delay along the path ABC and along the path ABD, as indicated by block 36. In alternate embodiments, the node A (or other device performing the technique 30) may also calculate the transmission delay using other delay determination techniques, such as by synchronizing the source and destination nodes using global positioning system (“GPS”) time.

Once the transmission delay along each of the paths ABC and ABD has been determined, the node A may utilize these delays, which are also referred to as the observed transmission delays, to calculate a joint characteristic function along each of the paths, ABC and ABD. In one embodiment, calculating the joint characteristic function includes performing a Fourier transform on a distribution of the observed transmission delays. For example, the node A may perform a two-variable Fourier transform.

As those of ordinary skill in the art will appreciate, performing a Fourier transform at this point is useful due to a computational phenomenon inherent in the frequency domain. As described above, in the time domain, the delay for a path (ABC, for example) is equal to the convolution of the link delay AB and the link delay BC. However, as described above, this convolution operation is so computationally complex that it is impractical or difficult to employ certain more-accurate modeling equations, such as mixture model equations or piece-wise constant equations in the time domain. However, in the frequency domain, the characteristic function for the path delay (ABC, again for example) is the product of the characteristic functions of link delay AB and the link delay BC. Although the above-described more accurate modeling equations are not amenable to convolution, they are amenable to multiplication in the frequency domain. As such, performing the calculations in the frequency domain, as described below, enables more accurate modeling equations to be employed to estimate the network tomography.

Returning to FIG. 2, the node A may also calculate another joint characteristic function of the delay along each path using one or more suitable modeling equations, such as the mixture model equation, the piece-wise constant equation, the quadratic equation, and so forth, as indicated by block 40. It will be appreciated by those of ordinary skill in the art that the modeling equations employed at this stage of the technique 30 are actually the characteristic functions of the time-space modeling equations.

For example, FIG. 3 is a flow chart illustrating an exemplary partial technique 50 for calculating link delays based on mixture model equations in accordance with one embodiment. As indicated by blocks 52 and 54, the technique 50 may begin by creating mixture model equations for each of the paths in the network system 10. In one embodiment, the mixture model equations in the time domain can be expressed as a probability mass/density function such as:

$${f}_{k} ( x ) = \sum {p}_{jk} {k}_{jk} ( x ) \qquad ( Equation 1 )$$

where fₖ(x) is the probability mass/density function for an individual data link 20-24, pⱼₖ is a probability greater than or equal to zero,

$$\sum {p}_{jk} = 1 ,$$

and kⱼₖ is a mixture kernel selected based on prior knowledge of the computer network 10. In one embodiment, kⱼₖ is set equal to I(j−1) where j=1, 2, . . . n, to use Equation 1 to create a multinomial modeling equation.

After the mixture model equations for the paths ABC and ABD have been created, the node A may be configured to solve the modeling equations such that the deviance from the characteristic function of the observed transmission delay as compared to modeling equation is minimized (see block 56). More specifically, the node A may select those values for the modeling equation that cause the modeling equations to yield a “modeled” path delay time for ABC and ABD as close as possible for that model equation to the observed path delay time. These selected values are the values that make the modeling equation most closely match the observed path delay time. In other words, the selected values provides an estimate of the actual link delays for the data links 20, 22, and 24. In this way, the above-described techniques may be employed to calculate an estimate of the link delays and, thus, the network tomography of the computer network 10.

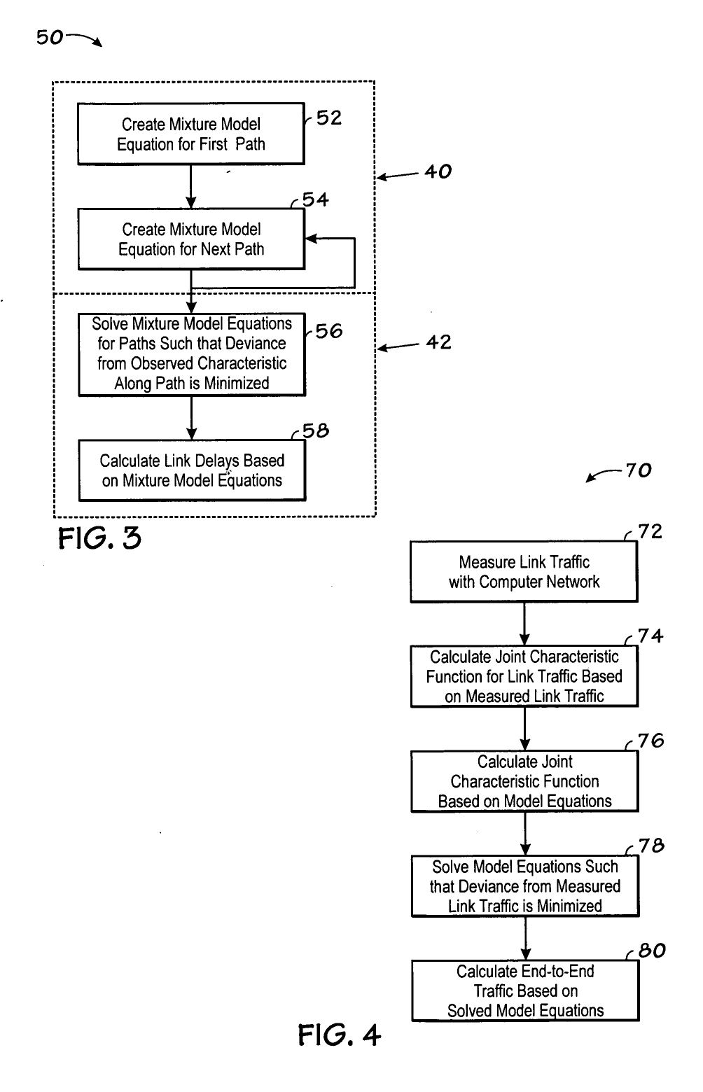

In addition, the techniques outlined above, may also be employed to calculate end-to-end network delay and/or network traffic based on observed network traffic along the data links of the end-to-end paths. For example, FIG. 4 is a flow chart illustrating an exemplary technique 70 for calculating network traffic in a computer network 10 based on data link traffic within the computer network 10 in accordance with one embodiment. As with the technique 30, the technique 70 may be performed by one of the nodes A-D or by another electronic device configured to monitor the computer network 10.

As indicated by block 72, the technique 70 may begin by measuring the data link traffic for the data links 20-24 along one the end-to-end paths within the computer network 10 (the path ABD, for example). In one embodiment, the nodes A-D may be configured to measure the data link traffic and to transmit this measurement to the node performing the technique 70. For example, the node A may be configured to measure a distribution of data link traffic for the data links 20-24. Next, the node A may be configured to calculate a joint characteristic function for observed data link traffic measurements, as indicated by block 74. In one embodiment, calculating the joint characteristic function for the observed traffic includes performing a two-variable Fourier transform on a joint distribution of the observed data link traffic measurements.

Next, the node A may calculate a joint characteristic function for the data link traffic using modeling equations, as indicated by block 76. For example, in one embodiment, node A may be configured to calculate a mixture model equation for the data link traffic. After the joint characteristic function based on model equations has been determined, the node A may solve the modeling equations such that the deviance from the observed data link traffic measurements is minimized, as indicated in block 78. Lastly, the end-to-end traffic may be calculated based on the solved modeling equations, as indicated in block 80.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

We claim:

1. A computer system configured:
to measure the transmission delay along a path from a source endpoint of a computer network to a plurality of destination endpoints of the computer network, wherein the path includes at least two data links and wherein at least one of the data links is shared by the plurality of destination endpoints for transmissions from the source endpoint;
to calculate a characteristic function of the measured transmission delay; and
to calculate a performance parameter of one of the data links based on the characteristic function.

2. The computer system, as set forth in claim 1, wherein the network tomography module is configured to calculate a link delay of one of the data links.

3. The computer system, as set forth in claim 1, wherein the network tomography module is configured to measure a distribution of transmission delays along the path.

4. The computer system, as set forth in claim 3, wherein the network tomography module is configured to calculate the characteristic function by performing a Fourier transform on the measured distribution of transmission delays.

5. The computer system, as set forth in claim 1, wherein the network tomography module is configured to calculate the performance factor by determining one or more model equation values that approximate the performance factor.

6. The computer system, as set forth in claim 1, wherein the network tomography module is configured to calculate the performance factor by solving a mixture model equation.

7. The computer system, as set forth in claim 1, wherein the network tomography module is configured to calculate the performance factor by solving a piece-wise linear equation.

8. The computer system, as set forth in claim 1, wherein the network tomography module is configured to calculate the performance factor by solving a quadratic modeling equation.

9. The computer system, as set forth in claim 1, wherein the computer system comprises the source endpoint.

10. A method of estimating link delays in a computer network, the method comprising:
measuring distributions of delays for transmitting data between a first endpoint and a second endpoint of the computer network;
evaluating a Fourier transform of each of the distributions; and
estimating a link delay on a data link within the computer network based on at least two evaluated Fourier transforms.

11. The method, as set forth in claim 10, comprising:
measuring a joint distribution of the delays for transmitting between the first endpoint and the second endpoint and the delays for transmitting between the second endpoint and a third endpoint, wherein the estimating is based on the distribution of the joint distribution.

12. The method, as set forth in claim 11, comprising:
evaluating a two-variable Fourier transform of the measured joint distribution, wherein the estimating is based at least partially on the two-variable Fourier transform of the joint distribution.

13. A tangible machine readable medium comprising:
code adapted to measure distributions of delays for transmitting data between a first endpoint and a second endpoint of the computer network;
code adapted to evaluate a Fourier transform of each of the distributions; and
code adapted to estimate a link delay on a data link within the computer network based on at least two evaluated Fourier transforms.

14. The tangible medium, as set forth in claim 13, comprising code adapted to measure a joint distribution of the delays for transmitting between the first endpoint and the second endpoint and the delays for transmitting between the second endpoint and a third endpoint, wherein the estimating is based on the distribution of the joint distribution.

15. The tangible medium, as set forth in claim 14, comprising code adapted to evaluate a two-variable Fourier transform of the measured joint distribution, wherein the estimating is based at least partially on the two-variable Fourier transform of the joint distribution.

16. A method of estimating traffic over an end-to-end network path, the method comprising:
measuring a network traffic distribution for each of a plurality of data links within the end-to-end network path;
evaluating a Fourier transform of each of the measured network traffic distributions; and
estimating the network traffic on the end-to-end network path based on at least two of the plurality of Fourier transforms.

17. The method, as set forth in claim 16, comprising measuring a joint distribution of the traffic transmitted between a first endpoint node and a first intermediate node and the first intermediate node and a second endpoint node, wherein the estimating is based on the distribution of the joint distribution.

18. The method, as set forth in claim 17, comprising evaluating a two-variable Fourier transform of the measured joint distribution, wherein estimating the network traffic is based on the two-variable Fourier transform of the joint distribution.
